(19) United States
(12) Patent Application Publication
(10) Pub. No.: US 2014/0126938 A1
(43) Pub. Date: May 8, 2014

(54) Hybrid Architecture for an Electrophotographic Imaging Device

(71) Applicant: LEXMARK INTERNATIONAL, INC., Lexington, KY (US)

(72) Inventors: Andrew Charles Hogan, Lexington, KY (US); Larry Steven Foster, Lexington, KY (US); Niko Jay Murell, Lexington, KY (US)

(73) Assignee: LEXMARK INTERNATIONAL, INC., Lexington, KY (US)

(21) Appl. No.: 13/668,647

(22) Filed: Nov. 5, 2012

(51) Int. Cl. G03G 15/01

(52) U.S. Cl. 399/302

(57) ABSTRACT

An imaging device is shown, including a plurality of color imaging units, each color imaging unit selectively depositing toner forming a distinct color toner image; an intermediate transfer member for cooperating with the color imaging units such that the color toner images are deposited thereon; and a black imaging unit for depositing black toner having a photoconductive member on which the black toner is deposited to form a black toner image. The intermediate transfer member and the black imaging unit are configured so that during a color print operation, color toner images deposited on the intermediate transfer member are deposited therefrom onto the photoconductive member of the black imaging unit, and the color toner images and the black toner image are subsequently deposited onto a to media sheet.

### CROSS REFERENCES TO RELATED APPLICATIONS

None

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates generally to electrophotographic imaging devices such as a printer or multifunction device having printing capability, and in particular to an imaging device in which color toner images created by color imaging units are transferred to a sheet of media via the photoconductive member of a black imaging unit which forms black toner images.

2. Description of the Related Art

For many users of color printing devices, a vast majority of media sheets are printed in monochrome using only black toner. As a result, print performance characteristics that relate to monochrome printing are often considered when determining a printing device to purchase. A need thus exists for a color printing device having improved monochrome printing performance.

### SUMMARY

Embodiments of the present disclosure overcome shortcomings in prior toner transfer architectures and satisfy a significant need for a hybrid architecture in which black toner is efficiently transferred to a media sheet. According to an example embodiment, there is shown an imaging device including a plurality of color imaging units, each imaging unit selectively depositing a distinct toner color; an intermediate transfer member for cooperating with the color imaging units such that color toner is deposited onto the intermediate transfer member to form a color toner image; and a black imaging unit for depositing black toner, including a photoconductive member on which the black toner is deposited to form a black toner image. The intermediate transfer member and the black imaging unit are configured so that during a color print operation, the color toner image previously deposited on the intermediate transfer member is deposited onto the photoconductive member of the black imaging unit and the color toner image and the black toner image are subsequently deposited from the photoconductive member of the black imaging unit onto a media sheet. By transferring toner directly to the media sheet from the photoconductive drum of the black imaging unit, the time to first print (TTFP) and time to first copy (TTFC) for the imaging device having the above-described architecture are generally no more than such times for a monochrome printer employing only a black imaging unit.

### BRIEF DESCRIPTION OF THE DRAWINGS

The above-mentioned and other features and advantages of the disclosed embodiments, and the manner of attaining them, will become more apparent and will be better understood by reference to the following description of the disclosed embodiments in conjunction with the accompanying drawings, wherein:

FIG. 1 is cross sectional side view of the imaging section of a known imaging device;

FIG. 2 is a cross sectional view of the imaging section of an imaging device according to an example embodiment;

FIG. 3 is cross sectional view of the imaging section of FIG. 3 in which the intermediate transfer member therein is in a retracted position; and

FIG. 4 is a cross sectional side view of an imaging device according to an example embodiment including the imaging section of FIG. 2.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Terms such as “first”, “second”, and the like, are used to describe various elements, regions, sections, etc. and are not intended to be limiting. Further, the terms “a” and “an” herein do not denote a limitation of quantity, but rather denote the presence of at least one of the referenced item.

Furthermore, and as described in subsequent paragraphs, the specific configurations illustrated in the drawings are intended to exemplify embodiments of the disclosure and that other alternative configurations are possible.

Reference will now be made in detail to the example embodiments, as illustrated in the accompanying drawings. Whenever possible, the same reference numerals will be used throughout the drawings to refer to the same or like parts.

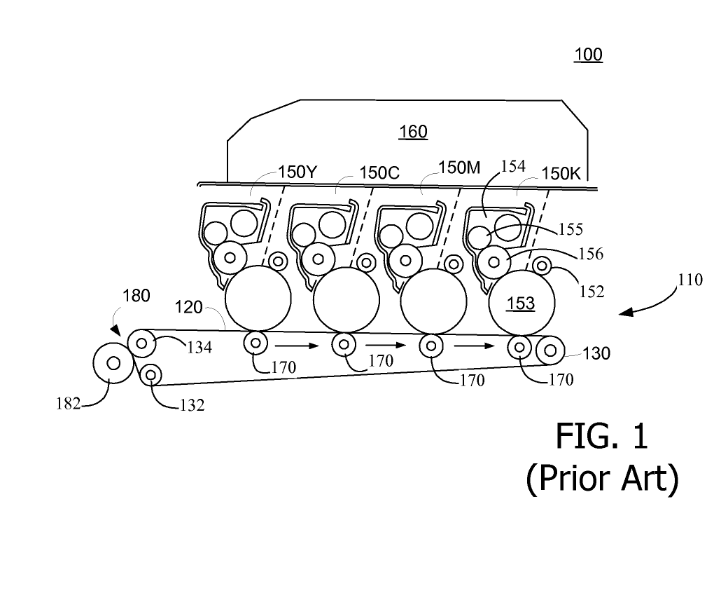

FIG. 1 illustrates one embodiment of the imaging section 100 of a known color image forming device. Imaging section 100 includes a first toner transfer area 110 with four imaging units 150 that are aligned horizontally, substantially extending from one side of the image forming device to an opposed side thereof. Imaging units 150 are disposed along an intermediate transfer member (ITM) 120. Each of the imaging units 150 holds a different color toner. The imaging units 150 are aligned in order relative to the direction of the ITM 120 with the yellow (Y) imaging unit 150Y being the most upstream, followed by cyan (C) imaging unit 150C, magenta (M) imaging unit 150M, and black (K) imaging unit 150K being the most downstream along ITM 120.

Each imaging unit 150 includes a toner reservoir 154 to contain the toner. One or more agitating members may further be positioned within the reservoir to move the toner, and a toner adder roller 155 is positioned in the reservoir 154 to move the toner to a developer roller 156. Each imaging unit 150 also includes a photoconductive member 153 that receives toner from developer roller 156. A charging member 152 is positioned to charge the photoconductive (PC) member or drum 153. In one embodiment, each of the imaging units 150 is substantially the same except for the color of toner appearing therein. For purposes of clarity in FIG. 1, the elements are labeled only in black imaging unit 150K.

It is understood that each imaging unit 150 may be operably coupled to a distinct toner bottle (not shown) which delivers toner to reservoir 154 as toners levels therein fall below a predetermined threshold.

During color image formation, the surface of each PC drum 153 is charged to a specified voltage, such as −800 volts, for example. At least one laser beam from a printhead 160 is directed to the surface of each PC drum 153 and discharges those areas it contacts to form a latent image thereon. In one embodiment, areas on the PC drum 153 illuminated by the laser beam are discharged to approximately −100 volts. The developer roller 156 of each imaging unit 150 then transfers toner to PC drum 153 to form a toner image thereon. The toner is attracted to the areas of PC drum 153 surface discharged by the laser beam from the printhead 160.

ITM 120 is disposed adjacent to each of imaging unit 150. In this embodiment, ITM 120 is formed as an endless belt disposed about drive roller 130, tension roller 132 and back-up roller 134. During image forming operations, ITM 120 moves past the imaging units 150 in a clockwise direction as viewed in FIG. 1. One or more of PC drums 153 applies a toner image in its respective color to ITM 120. For mono-color images, a toner image is applied from a single imaging unit 150, such as black imaging unit 150K. For multi-color images, toner images are applied from two or more imaging units 150. In one embodiment, a positive voltage field formed in part by transfer roller 170 attracts the toner image from the associated PC drum 153 to the surface of moving ITM 120.

ITM 120 rotates and collects the one or more toner images from the one or more imaging units 150 and then conveys the one or more toner images to a media sheet at a second transfer area 180. Second transfer area 180 includes a second transfer nip formed between back-up roller 134 and a second transfer roller 182.

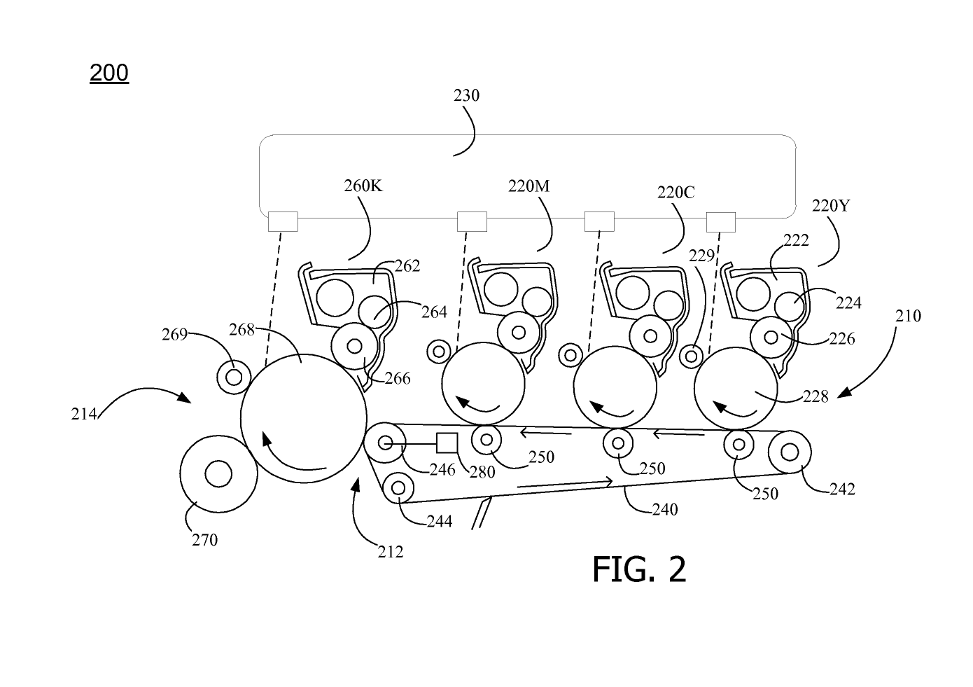

FIG. 2 illustrates an imaging section 200 according to an example embodiment. Imaging section 200 includes a first transfer area 210, a second transfer area 212 and a third transfer area 214. First transfer area 210 includes three imaging units or stations 220 that extend along ITM 240. Each of the imaging units 220 holds a different toner color. The imaging units 220 are aligned in order relative to the direction of ITM 240, with the yellow (Y) imaging unit 220Y being the most upstream, followed by cyan (C) imaging unit 220C and magenta (M) imaging unit 220M.

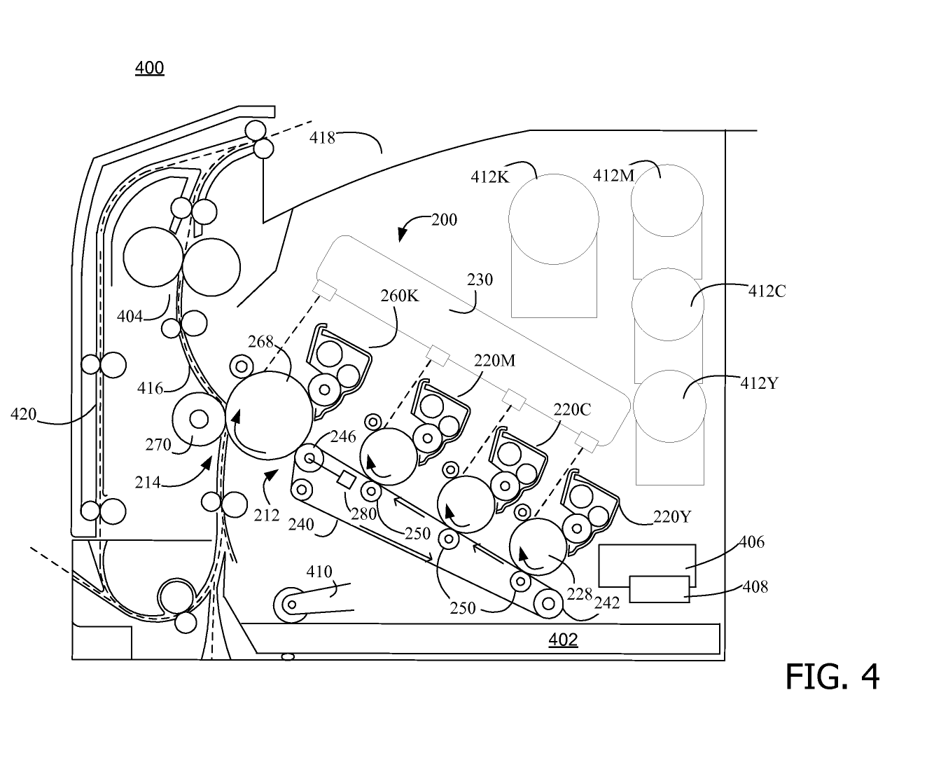

Each imaging unit 220 includes a toner reservoir 222 to contain the toner which may be replenished as needed from a toner bottle 412 (see FIG. 4). One or more agitating members may be positioned within the reservoir to move the toner, and a toner adder roller 224 is positioned in the reservoir 222 to move the toner to a developer roller 226. Each imaging unit 220 also includes a photoconductive drum 228 that receives toner from the developer roller 226. A charging member 229 is positioned to charge PC drum 228. In one embodiment, each of the imaging units 220 is substantially the same except for the color of toner. For purposes of clarity in FIG. 2, however, the elements are labeled on only the yellow imaging unit 220Y.

During color image formation, the surface of each PC drum 228 is charged to a specified voltage, such as −800 volts, for example. At least one modulated laser beam from a printhead 230 is directed to the surface of each PC drum 228 and discharges those areas it contacts to form a latent image thereon. In one embodiment, areas on the PC drum 228 illuminated by the laser beam are discharged to approximately −100 volts, for example. Developer roller 226 of each imaging unit 220 then transfers toner to PC drum 228 to form a toner image thereon. The toner is attracted to the areas of the PC drum 228 surface discharged by the laser beam from the printhead 230.

ITM 240 is disposed adjacent to each imaging unit 220. In this embodiment, ITM 240 is formed as an endless belt disposed about drive roller 242, tension roller 244 and backup roll 246. During color image forming operations, ITM 240 moves past the imaging units 220 in a counterclockwise direction as viewed in FIG. 2. At least one of the PC drums 228 applies a color toner to ITM 240. In one embodiment, a positive voltage field formed by each transfer roller 250 attracts a toner image from its associated PC drum 228 to the surface of the moving ITM 240.

Imaging section 200 further includes black imaging unit or station 260K having toner reservoir 262 to contain toner. Reservoir 262 may be replenished as needed by a toner bottle 412B containing black toner (see FIG. 4). An adder roll 264 moves the toner to a developer roller 266, and PC drum 268 which receives toner from developer roller 266. Charge member 269 is positioned to charge its corresponding PC drum 268. Though black imaging unit 260K may include the same components found in imaging units 220, PC drum 268 may be larger than PC drums 228. In an example embodiment, the diameter of PC drum 268 is about 60 mm and the diameter of each PC drum 228 is about 30 mm. A benefit of the larger size of PC drum 268 is an extended life thereof. It is understood that PC drums 228 and 268 may be sized differently relative to each other, including having the same size, and that the particular sizes chosen may depend upon the limitations or constraints associated with the particular imaging section 200 and/or imaging device 100 used, for example.

According to the example embodiment, a color toner image that is transferred to ITM 240 from imaging units 220 is then transferred to PC drum 268 of black imaging unit 260 at second transfer area 212. Second transfer area 212 may be formed between PC drum 268 of black imaging unit 260 and backup roll 246. This “back transfer” of toner from ITM 240 to PC drum 268 may be accomplished by the application of the appropriate electric field formed from voltages that are applied to backup roll 246 and charge member 269. By transferring the color toner image to PC drum 268 of black imaging unit 260, all toner is subsequently transferred to a media sheet at third transfer area 214.

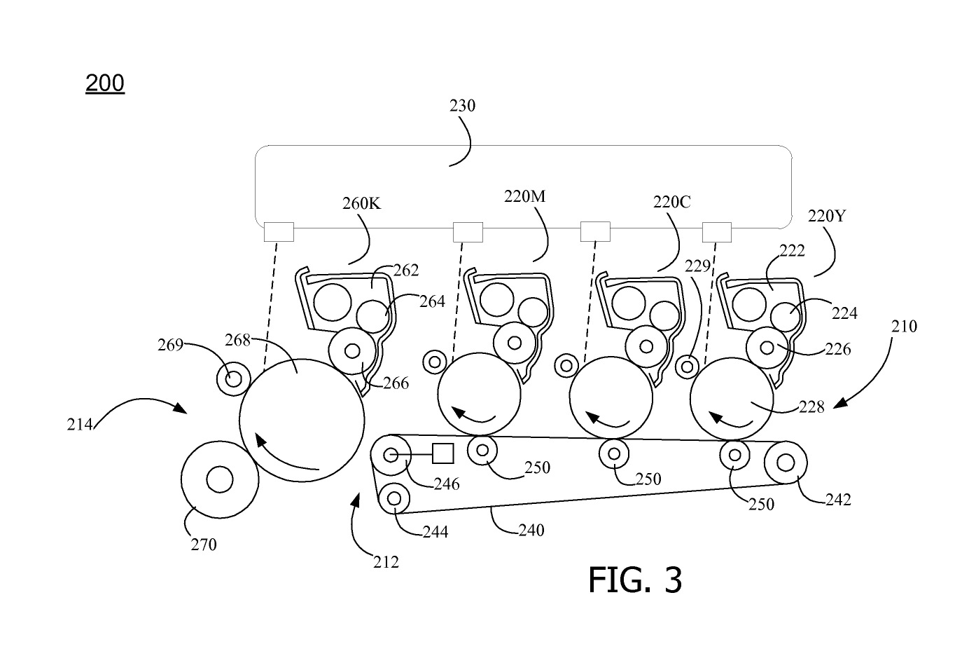

Imaging section 200 may further include a retraction mechanism 280 operably coupled to backup roll 246 for selectively retracting backup roll 246 from engagement with PC drum 268 of black imaging unit 260. Retraction mechanism 280 may be activated to retract backup roll 246 from PC drum 268, for example, following transfer of toner thereto, and during a print operation in which only black toner is used. FIG. 2 shows backup roll 246 engaged with PC drum 268 and FIG. 3 shows backup roll 246 retracted therefrom. Retraction mechanism 280 may utilize a motor for moving backup roll 246 between the retracted and unretracted positions. Advantageously, retraction mechanism 280 does not alter or otherwise affect the media path for media sheets passing through third transfer area 214.

FIG. 4 illustrates an imaging device 400 utilizing imaging section 200. Imaging section 200 is disposed within imaging device 400 so that imaging units 220 and 260 are aligned along an axis that is angled between vertical and horizontal axes. The angle may be between about 30 degrees and about 70 degrees from the horizontal. In the example embodiment, black imaging unit 260K is disposed in an elevated position relative to imaging units 220. In this way, third transfer area 214 is situated between media input tray 402 and fuser assembly 404 such that the TTFC and TTFP are reduced.

A benefit of imaging section 200 being disposed along an axis that is angled as shown in FIG. 4 is that printhead 230 is disposed further away from heat-generating fuser assembly 404 and is less affected by elevated temperatures thereof as a result.

Imaging device 400 also includes controller 406 which generally controls the operation thereof, including imaging section 200 such as imaging units 220 and 260, ITM 240, transfer roller 250, drive roller 242, and backup roll 246. Controller 406 may include one or more processors, software, firmware and/or hardware logic necessary to control the functions of imaging device 400, and may be implemented as one or more application specific integrated circuits (ASICs). Controller 406 may also include or be associated with a memory 408 which may be any volatile and/or non-volatile memory such as, for example, random access memory (RAM), read only memory (ROM), flash memory and/or non-volatile RAM (NVRAM). A pick mechanism 410, controlled by controller 406, may pick the top media sheet from a stack thereof situated in media input tray 402 and move the picked sheet towards third transfer area 214 for receiving a toner image.

Imaging device 400 further includes toner bottles 412, each for supplying toner to its corresponding imaging unit as needed. Toner bottle 412K supplies black toner to black imaging unit 260K, toner bottle 412M supplies magenta toner to imaging unit 220M, toner bottle 412C supplies cyan toner to imaging unit 220C and toner bottle 412Y supplies toner to imaging unit 220Y. Toner delivery from each toner bottle 412 to its corresponding imaging unit may be controlled by controller 406. Toner bottles 412 may be accessed by a user for replacement via one or more doors disposed along imaging device 400.

As shown in FIG. 4, a media path 416 extends largely from media input tray 402 to media output area 418, downstream of fuser assembly 404. Duplex media path 420 extends from a location downstream of fuser assembly 404 to a point upstream of third transfer area 214 so that a second side of a media sheet may be imaged during a duplex print operation.

Controller 406 may coordinate the timing of an imaging operation with a media feed operation whereby a top sheet of a stack of media is picked from media input tray 402 by pick mechanism 410 and delivered to third transfer area 214. For a color print operation, prior to or during the time the top media sheet is picked by pick mechanism 410 and moved towards third transfer area 214, a color toner image is formed on ITM 240 by imaging units 220. In particular, imaging unit 220Y may form a yellow toner image on ITM 240, followed by imaging unit 220C selectively forming a cyan toner image on ITM 240 that is aligned with the yellow toner image, and imaging unit 220M selectively forming a magenta toner image on ITM 240 that is aligned with the yellow and cyan toner images so as to form a single color toner image. It is understood that any one or more of imaging units 220 may form a color toner image on ITM 240 during a color print operation.

A black toner image may be formed on photoconductive drum 268 of imaging unit 260K during the color print operation, the particular timing of which is chosen so that the black toner image is aligned with the color toner image appearing on ITM 240 when the color toner image is transferred at second transfer area 212 from ITM 240 to photoconductive drum 268. Such timing may depend upon the size of photoconductive drum 268 of black imaging unit 260K relative to the size of the photoconductive drum 228 of imaging units 220 and the spacing along ITM 240 between imaging unit 220Y and second transfer area 212. Once the color toner image is back transferred to photoconductive drum 268, forming a complete image with the black toner image, retraction mechanism 280 may retract backup roll 246 so that ITM 240 no longer contacts photoconductive drum 268 of black imaging unit 260K. In addition, around this time imaging units 220 may no longer be activated, thereby reducing churn.

Movement of the picked media sheet is timed so that it enters third transfer area 214 at the same time as the complete toner image on photoconductive drum 268 reaches same. Following transfer of the complete image onto the picked media sheet, the sheet passes through fuser assembly 404 where the toner is fused to the media sheet. Upon exiting fuser assembly 404, the sheet may either be fed into duplex path 420 for printing on a second surface thereof, or ejected from imaging device 400 at output area 418.

For a monochrome print operation only involving black toner, retraction mechanism 280 may retract backup roll 246 from photoconductive drum 268 of imaging unit 260K, and imaging units 220 and ITM 240 are not activated for participating in the print operation, thereby reducing churn. A black toner image is formed on photoconductive drum 268 which is transferred to a picked media sheet at third transfer area 214. By transferring the black toner image directly from photoconductive drum 268 onto the picked media sheet, imaging section 200 advantageously allows for substantially the same toner transfer efficiency in performing a monochrome print operation as the toner transfer efficiency in monochrome printing devices.

According to an example embodiment, imaging device 400 may be initially configured as a monochrome imaging device which only provides black toner images, without imaging units 220, ITM 240, toner bottles 412M, 412C and 412Y, and the components supporting same. Imaging units 220, ITM 240, toner bottles 412M, 412C and 412Y and their supporting components may be acquired separately from imaging device 400, either individually or collectively as a single, insertable unit, in order to upgrade the monochrome machine to include color imaging capability.

It is understood that imaging device 400 may be a multifunction product including scan, copy and/or facsimile functionality.

The foregoing description of several methods and example embodiments has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. An imaging device, comprising:
a plurality of color imaging units, each imaging unit selectively depositing a distinct color toner;
an intermediate transfer member for cooperating with the color imaging units such that a color toner image is formed thereon; and
a black imaging unit for depositing black toner, comprising a photoconductive member on which the black toner is deposited to form a black toner image thereon;
wherein the intermediate transfer member and the black imaging unit are configured so that during a color print operation, the color toner image formed on the intermediate transfer member is transferred therefrom onto the photoconductive member of the black imaging unit, and the color toner image and the black toner image are subsequently transferred onto a media sheet.

2. The imaging device of claim 1, wherein the intermediate transfer member comprises an endless belt.

3. The imaging device of claim 1, wherein each of the plurality of color imaging units includes a photoconductive member, and the photoconductive member of the black imaging unit is larger than the photoconductive member of each color imaging unit.

4. The imaging device of claim 1, further comprising a retraction mechanism operably associated with the intermediate transfer member, wherein the imaging device is configurable to perform a color print operation and a monochrome print operation, and during a monochrome print operation, only black toner is transferred to the media sheet and the intermediate transfer member is retracted from the photoconductive member of the black imaging unit so as to be spaced therefrom.

5. The imaging device of claim 1, wherein the plurality of color imaging units and the black imaging unit are disposed substantially along an axis that is angled between horizontal and vertical.

6. The imaging device of claim 5, further comprising a housing in which the plurality of color imaging units, the intermediate transfer member and the black imaging unit are disposed, wherein the black imaging unit is disposed at a higher elevation than the plurality of color imaging units within the housing.

7. The imaging device of claim 1, wherein the color toner image and the black toner image are transferred to the media sheet during a color print operation in a single step.

8. The imaging device of claim 1, wherein the black toner is transferred to the media sheet during any print operation in a single step.

9. An imaging device, comprising:
a first imaging unit comprising a photoconductive member for depositing a first type of toner; and
at least one second imaging unit, each second imaging unit comprising a photoconductive member for depositing a second type of toner;
wherein the first imaging unit and the at least one second imaging unit are controlled such that during a print operation, the second type of toner is transferred from the photoconductive member of the at least one second imaging unit to the photoconductive unit of the first imaging unit for subsequent transfer to a media sheet.

10. The imaging device of claim 9, further comprising an intermediate transfer member coupled between the at least one second imaging unit and the photoconductive member of the first imaging unit, wherein during the print operation the at least one second imaging unit transfers the second type of toner to the intermediate transfer member for subsequent transfer to the photoconductive member of the first imaging unit.

11. The imaging device of claim 10, wherein the intermediate transfer member comprises an endless belt.

12. The imaging device of claim 10, wherein the photoconductive member of the first imaging unit is larger than the photoconductive member of the at least one second imaging unit.

13. The imaging device of claim 9, further comprising a housing in which the first imaging unit and the at least one second imaging unit are disposed, wherein first imaging unit is disposed at a higher elevation than the at least one second imaging unit in the housing.

14. The imaging device of claim 9, wherein toner of the first type is deposited onto the media sheet directly from the photoconductive member of the first imaging unit.

15. The imaging device of claim 9, further comprising a decoupling mechanism coupled between the first imaging unit and the second imaging unit such that the at least one second imaging unit is decoupled from the first imaging unit during a printing operation in which only toner of the first type is to be transferred to the media sheet.

16. The imaging device of claim 15, further comprising an intermediate transfer mechanism coupled between the first imaging unit and the at least one second imaging unit, wherein the decoupling mechanism decouples the intermediate transfer mechanism from the first imaging unit during the printing operation in which only toner of the first type is to be transferred to the media sheet.

17. The imaging device of claim 9, further comprising a housing in which the first imaging unit and the at least one second imaging unit are disposed, wherein the at least one second imaging unit comprises a plurality of second imaging units, the first imaging unit and the second imaging units are substantially linearly arranged within the housing with the first imaging unit disposed at an elevation within the housing that is higher than an elevation of each of the second imaging units therein.

18. The imaging device of claim 17, wherein the intermediate transfer mechanism and the second imaging units are insertable into the housing as a single assembly.
